(19) United States
(12) Patent Application Publication
(10) Pub. No.: US 2013/0003700 A1
(43) Pub. Date: Jan. 3, 2013

(54) Method and Device for Triggering Radio Resource Control Connection Re-Establishment

(75) Inventors: Jian Zhang, Shenzhen (CN); Yada Huang, Shenzhen (CN)

(73) Assignee: ZTE CORPORATION, Shenzhen, Guangdong (CN)

(21) Appl. No.: 13/583,640

(22) PCT Filed: Jan. 18, 2011
(86) PCT No.: PCT/CN2011/070367

§ 371 Date: Sep. 10, 2012

(30) Foreign Application Priority Data
Apr. 23, 2010 (CN) 201010156881.8

(51) Int. Cl. H04W 74/08; H04W 36/00; H04W 72/04

(52) U.S. Cl. 370/331; 370/328; 370/329

(57) ABSTRACT

The disclosure discloses a method for triggering Radio Resource Control (RRC) connection re-establishment, comprising: setting a random access policy for a UE, and further comprising: when the random access procedure initiated by the UE according to the set random access policy is failed, the RRC connection re-establishment procedure is triggered. The disclosure further discloses a device for triggering RRC connection re-establishment, comprising: a setting unit, an initiating unit, a determining unit and a triggering unit, wherein the setting unit is configured to setting a random access policy for a UE; the initiating unit is configured to initiating random access procedure according to the set random access policy; the determining unit is configured to determining whether the random access procedure initiated by the initiating unit is successful, and triggering the triggering unit if not; and the triggering unit is configured to triggering RRC connection re-establishment procedure. The technical solution of the disclosure is easy, and has the advantages of high inheritance of the related art, small delay, fast recovery of radio link and the like.

### TECHNICAL FIELD

The disclosure relates to a random access technology, in particular to a method and device for triggering Radio Resource Control (RRC) connection re-establishment.

### BACKGROUND

In a Long Term Evolution (LTE) wireless system of Third Generation Partnership Project (3GPP), a User Equipment (UE) in RRC_CONNECTED state needs to trigger random access procedure to acquire uplink synchronization with a network side, i.e., an Evolved Universal Terrestrial Radio Access Network (E-UTRAN) which is also called an Enhanced NodeB (eNB) when the following five events occur. The five events are specifically: RRC connection re-establishment procedure; handover; the arrival of downlink data in the RRC_CONNECTED state needs the random access procedure, for example, when uplink synchronization state is “non-synchronized”; the arrival of the uplink data in the RRC_CONNECTED state needs the random access procedure, for example, when uplink synchronization state is “non-synchronized”; or there is no available Physical Uplink Control Channel (PUCCH) resource for the transmission of a Schedule Request (SR); and the location destination in the RRC connection state needs the random access procedure, for example, the location of UE needs timing advance. The random access procedure is divided into a competition-based random access procedure and a non-competition-based random access procedure. The random access procedure triggered by the five events above can be the competition-based one; and the random access procedure triggered by the events of handover, the arrival of downlink data and the location can be the non-competition-based random access procedure. The random access procedure can be initiated by the PDCCH order or the Medium Access Control (MAC) layer of UE; optionally, a PDCCH order or a RRC signaling can allocate dedicated random access preamble for the UE and the random access procedure is non-competition-based, otherwise, the UE needs to select the random access preamble, and the random access procedure is competition-based. The UE selects random access resources, including selecting the random access preamble, the time-frequency resources of Physical Random Access Channel (PRACH) and the like. The random access procedure cannot succeed until being performed for one or more times, or still not succeed even being performed for the maximum times. The eNB configures the random access preamble transmission maximum times (preambleTransMax) parameter for the UE in advance by system information 2 (SIB2).The counter preamble_transmission_counter of random access preamble sent by UE is initialized to be 1; the counter adds 1 every time the random access procedure is judged to be failed; and when the counter is preambleTransMax+1, it is indicated that the failure times of the random access procedure reaches maximum times, and MAC layer indicates the random access problem of an upper protocol layer, such as an RRC layer. After the RRC layer of the UE receives the indication from the MAC layer, if timers T300, T301, T304, and T311 are not running, Radio Link Failure (RLF) is considered to be detected; and the RRC connection re-establishment procedure is triggered when the security of an Access Stratum (AS) has been activated. The starting and stopping conditions of the timers are listed in tables of the 7.3 section of the 3GPP protocol specification TS36.331. When an UE in an RRC idle state (RRC_IDLE) initially accesses a network, T300 is configured to start at the time of sending an RRC connection request message RRCConnectionReestabilshmentRequest. T301 starts when a UE sends an RRC connection re-establishment request message RRCConnectionReestabilshmentRequest and stops when the UE receives an RRC connection re-establishment message RRCConnectionReestablishment or an RRC connection re-establishment rejection message RRCConnectionReestablishmentReject or a selected cell becomes unsuitable. T304 starts when the UE sends an RRC connection reconfiguration message RRCConnectionReconfiguration including a mobility control information message MobilityControl Info or receives a mobility command MobilityFromEUTRACommand message from an Evolved Universal Mobile Telecommunication System (UMTS) Terrestrial Radio Access (EUTRA) including a cell change order CellChangeOrder, and stops when switching to the EUTRA is successfully completed or a change order of a cell is met. T311 starts when the RRC connection re-establishment is initiated and stops when a proper E-UTRA cell is selected or other Radio Access Technology (RAT) is used.

A Carrier Aggregation (CA) technology is adopted in Long Term Evolution Advanced (LTE-A) system in order to provide higher data rate for mobile subscriber. The maximum transmission bandwidths of the LTE system in downlink and uplink are 20 MHz, and the CA of the LTE-A system aggregates two or more component carriers (CCs) in downlink and/or uplink to support transmission bandwidths over 20 MHz. The LTE-A system of 3GPP Rel-10 has a maximum transmission bandwidths of less than 100 MHz in downlink and uplink and supports the aggregation of up to 5 CCs respectively in downlink and uplink. The LTE-A UE with the CA capability can transceive data on multiple CCs simultaneously, and in this application, the following UEs are this kind of UEs unless otherwise specified. The UE is provided with a downlink primary component carrier (DL PCC) and an uplink primary component carrier (UL PCC) and can be provided with 0 to 4 downlink secondary component carriers (DL SCCs) and/or 0 to 4 uplink secondary component carriers (UL SCCs), and the total number of UL CCs is less than or equal to that of the DL CCs. The UL CC at least has one associated DL CC in intra-band, and the association relationship between uplink and downlink carriers is configured by system information broadcast (SIB2) or dedicated signaling, such as RRC signaling. When the DL PCC is the CC when the UE initially accesses to eNB, the UE can change the DL PCC into other DL CC by RRC connection reconfiguration when the UE is in the RRC_CONNECTED state. The UL PCC also can be reconfigured into other UL CC by SIB2 or dedicated signaling, such as RRC signaling. At any time, the UE in RRC_CONNECTED state at least remains the configuration of one DL PCC and one UL PCC. When detecting RLF, the DL PCC will trigger RRC connection re-establishment procedure, and the RLF of the DL SCC does not trigger such procedure. The UL PCC is provided with PUCCH resources for sending signaling like Hybrid Automatic Repeat Request Acknowledgement/Negative Acknowledgement (HARQ ACK/NACK), SR, Periodic Channel Quality Indicator (CQI) and the like.

In LTE-A Rel-10 CA, all the CCs are backward compatible. From the point of view of cell or eNB, each UL CC is provided with a random access channel (RACH) resource. From the point of view of UE, in the configured UL CC, the RACH resources on some UL CCs may not be configured for the UE to use, so certain UE may select available RACH resources from part of configured UL CCs thereof. The UE can initiate the random access procedure on more than one UL CC, and the random access procedure is only one at any time and can be performed in series on multiple CCs respectively or in parallel on multiple UL CCs. When the LTE-A system only supports a single TA, the random access procedure only needs to be performed on one UL CC at any time, and the random access procedure may be initiated on other UL CCs by selecting only when the random access procedure on certain UL CC is failed. In case of supporting multiple TAs, the random access procedure can be performed in series on multiple UL CCs respectively, and the random access procedure may also be initiated on other UL CCs even random accesses successfully on one UL CC; or the random access procedure can be performed in parallel on multiple UL CCs. As a result, in the LTE-A, when the failure times of random access procedure on one UL CC reaches the maximum times preambleTransMax, it does not necessarily mean RLF and the initiation of RRC connection re-establishment. The UE selects to initiate the random access only on the UL PCC, and if the failure times of random access reaches the maximum times, the MAC layer indicates the random access problem on the RRC layer; or the UE selects to initiate the random access on any UL CC, and if the failure times of the random access reaches the maximum times, the MAC layer indicates the random access problem on the RRC layer; and the two methods above are consistent with corresponding method in the LTE system. Or, if the failure times of random access of the UE on certain UL CC reaches the maximum times, and then the UE tries to initiate the random access on other UL CCs until the failure times of the random access on all the UL CCs reaches the maximum times, the MAC layer indicates the random access problem on the RRC layer. This method does not take the radio condition of UL CC, configuration of RACH resources, delay, selection method of UL CC, the repeated selection performance of certain UL CC and the like into consideration.

### SUMMARY

In view of this, the main objective of the disclosure is to provide a method and device for triggering RRC connection re-establishment, which can improve the recovery efficiency of a radio link.

In order to fulfill the objective, the technical solution of the disclosure is implemented as follows:

A method for triggering RRC connection re-establishment, including setting a random access policy for a UE, and further including:

when the random access procedure initiated by the UE according to the set random access policy is failed, the RRC connection re-establishment procedure is triggered.

Preferably, the random access policy is: the UE initiates random access on set UL CCs.

Preferably, the set UL CCs include a UL PCC and at least one UL SCC; and

the failed random access procedure initiated by the UE according to the set random access policy is:

when the UE first initiates the random access procedure on UL SCCs and the random access procedure initiated on at least one UL SCC is failed, and the UE then initiates the random access procedure on the UL PCC and the random access procedure initiated on the UL PCC is failed, it is determined that the random access procedure initiated on the set UL CCs is failed.

Preferably, the set UL CCs are UL PCCs; and

the failed random access procedure initiated by the UE according to the set random access policy is:

when the UE first initiates the random access procedure on the UL PCCs and the random access procedure initiated on the UL PCCs is failed, it is determined that the random access procedure initiated on the set UL CCs is failed.

Preferably, the set UL CCs are specific UL CCs; and

the failed random access procedure initiated by the UE according to the set random access policy is:

when the random access procedure initiated on the specific UL CCs is failed, it is determined that the random access procedure initiated on the set UL CCs is failed.

Preferably, the specific UL CCs are the ones with the best radio channel condition,

the ones whose associated DL CCs have the minimum path loss,

the ones whose associated DL CCs have the same frequency band with that of the UL CCs and the minimum path loss,

the ones having the minimum path loss,

the ones having the maximum Power Headroom Report (PHR), or,

the ones nearest to Random Access Channel (RACH) resources in time domain.

Preferably, the random access policy is: a maximum number of UL CCs for the initiation of random access attempt are set for the UE; and

the failed random access procedure initiated by the UE according to the set random access policy is:

when the UE initiates the random access procedure on the selected UL CCs and the amount of the selected UL CCs reaches the set maximum amount but the random access procedure is failed, it is determined that the initiated random access procedure is failed.

Preferably, the selected UL CCs include UL PCCs and UL SCCs; or, only include UL SCCs.

Preferably, the random access policy is: the set of UL CCs for the initiation of random access is set for the UE; and

the failed random access procedure initiated by the UE according to the set random access policy is:

when the random access procedure initiated by the UE on all the UL CCs in the set of the UL CCs is failed, it is determined that the initiated random access procedure is failed.

Preferably, the method further includes:

when the failure times of the random access procedure initiated on each UL CC reaches the set preambleTransMax, it is determined that the random access procedure initiated on the UL CCs is failed; and the failure times of the random access procedure initiated on the UL CCs does not exceed the set preambleTransMax.

Preferably, the triggering of the RRC connection re-establishment procedure is:

after the UE determines that the random access procedure initiated according to the set random access policy is failed, an MAC layer indicates the random access problem of an upper protocol layer, such as an RRC layer; the upper protocol layer receives the indication of the MAC layer and considers it to be RLF, and then triggers the RRC connection re-establishment procedure.

Preferably, before the triggering of the RRC connection re-establishment procedure, the method further includes: determining whether corresponding timers are running and triggering the RRC connection re-establishment procedure when they are not running.

Preferably, the corresponding timers include T301, T311, and T304; and

the step of determining whether corresponding timers are running is: under the condition of the random access procedure triggered by the RRC connection re-establishment event, determining whether the T301 and/or T311 is running; and under the condition of the random access procedure triggered by the handover event, determining whether the T304 is running.

Preferably, the method further includes: setting the timer Tx under the condition of the random access procedure triggered by the event that the arrival of the downlink data needs the random access procedure, the timer Ty under the condition of the random access procedure triggered by the event that the arrival of the uplink data needs the random access procedure, and the timer Tz under the condition of the random access procedure triggered by the event that the location of the UE needs the random access procedure, wherein the timers Tx, Ty and Tz are started when the UE initiates the random access procedure on the first selected UL CC; and

before the triggering of the RRC connection re-establishment procedure, the method further includes: determining whether the corresponding timers expire; and triggering the RRC connection re-establishment procedure if so, wherein the corresponding timers are at least one of the Tx, Ty and Tz.

A device for triggering RRC connection re-establishment includes a setting unit, an initiating unit, a determining unit and a triggering unit, wherein

the setting unit is configured to setting a random access policy for a UE;

the initiating unit is configured to initiating random access procedure according to the set random access policy;

the determining unit is configured to determining whether the random access procedure initiated by the initiating unit is successful, and triggering the triggering unit if not; and

the triggering unit is configured to triggering RRC connection re-establishment procedure.

Preferably, the random access policy is: the UE initiates random access on set UL CCS.

Preferably, the set UL CCs include a UL PCC and at least one UL SCC; and the determining unit further determines that: the random access procedure initiated on the set UL CCs is failed when the initiating unit first initiates the random access procedure on the UL SCCs and the random access procedure initiated on at least one of the UL SCCs is failed, and the initiating unit initiates the random access procedure on the UL PCC and the random access procedure initiated on the UL PCC is failed.

Preferably, the set UL CCs are the UL PCCs; and

the determining unit further determines that: the random access procedure initiated on the set UL CCs is failed when the initiating unit first initiates the random access procedure on the UL PCCs and the random access procedure initiated on the UL PCCs is failed.

Preferably, the set UL CCs are specific UL CCs; and

the determining unit further determines: the random access procedure initiated on the set UL CCs is failed when the random access procedure initiated by the initiating unit on the specific UL CCs is failed.

Preferably, the specific UL CCs are the ones with the best radio channel condition,

the ones whose associated DL CCs have the minimum path loss,

the ones whose associated DL CCs have the same frequency band with that of the UL CCs and the minimum path loss,

the ones having the minimum path loss,

the ones having the maximum PHR, or

the ones nearest to the RACH resources in time domain.

Or, the random access policy is: a maximum number of UL CCs for the initiation of the random access attempt are set for the UE; and

the determining unit further determines: the initiated random access procedure is failed when the initiating unit initiates the random access procedure on the selected UL CCs, the amount of the selected UL CCs reaches the set maximum amount but the random access procedure is failed.

Or, the random access policy is: the set of UL CCs for the initiation of random access is set for the UE; and

the determining unit further determines that: the initiated random access procedure is failed when the random access procedure initiated by the initiating unit on all the UL CCs in the set of the UL CCs is failed.

In the disclosure, by resetting the way of triggering the RRC connection re-establishment under the condition of failure radio access procedure, and on the premise of being compatible with the existing way of triggering the RRC connection re-establishment, the delay of the RRC connection re-establishment of the UE is greatly reduced and the radio link can be recovered as fast as possible. Specifically, the technical solution of the disclosure is easy and feasible, and has the advantages of high inheritance of the related art, small delay, fast recovery of radio link and the like.

### BRIEF DESCRIPTION OF THE DRAWINGS

FIG. 1 is a flowchart of a method for triggering RRC connection re-establishment in the first embodiment of the disclosure;

FIG. 2 is a flowchart of a method for triggering RRC connection re-establishment in the second embodiment of the disclosure;

FIG. 3 is a flowchart of a method for triggering RRC connection re-establishment in the third embodiment of the disclosure; and

FIG. 4 is a diagram showing the composition structure of a device for triggering RRC connection re-establishment in the disclosure.

### DETAILED DESCRIPTION

To make the objective, technical solution and advantages of the disclosure clearer, the disclosure is further described below with reference to embodiments and drawings in detail.

### First Embodiment

In the embodiment, whether the random access procedure initiated on the MAC layer of the UE is successful or not is determined by judging whether the random access procedure initiated on a UL PCC is successful; when the random access procedure initiated by the UE is failed, the random access problem of the upper protocol layer, such as the RRC layer, is indicated; and the upper protocol layer, such as the RRC layer, triggers the RRC connection re-establishment procedure, which is described below in detail.

It is assumed that the UE selects to initiate the random access procedure on a UL SCC firstly, if the failure times of the random access procedure reaches the maximum times preambleTransMax, then the random access procedure is selected to be initiated on a UL PCC; if the failure times of the random access procedure reaches the maximum times preambleTransMax, the MAC layer indicates the random access problem of an upper protocol layer, such as the RRC layer; and here, the preambleTransMax is a set value in related protocols. When there are more than two UL SCCs, it is able to directly select to initiate the random access procedure on a UL PCC after the random access procedure initiated on one UL SCC is failed, or select to continuously initiate the random access procedure on the rest UL SCC, the specific selection way is configured in the UE. While selecting the UL SCC, one UL SCC cannot be selected twice before the selection of the UL PCC.

The RRC layer receives the indication from the MAC layer, considers it to be RLF and triggers the RRC connection re-establishment procedure.

It is assumed that the UE selects to initiate the random access procedure on a UL PCC firstly, if the failure times of the random access procedure reaches the maximum times preambleTransMax, the MAC layer indicates the random access problem of the upper protocol layer, such as the RRC layer; and

the RRC layer receives the indication from the MAC layer, considers it to be RLF and triggers the RRC connection re-establishment procedure.

Or, under two conditions above, the RRC layer receives the random access problem indicated by the MAC layer, considers it to be RLF when timers are not running and triggers the RRC connection re-establishment procedure. The timer is T301 and T311 under the condition of the random access procedure triggered by RRC connection re-establishment event, and is T304 under the condition of the random access procedure triggered by handover event; the defining, starting and stopping of the timers T301, T311 and T304 are completely the same as that in the related art and are stipulated in the related protocols, thereby needing no further description.

Or, the timer is a newly-defined timer Tx under the condition of the random access procedure triggered by the event that the arrival of downlink data needs the random access procedure, and is a newly-defined timer Ty under the condition of the random access procedure triggered by the event that the arrival of uplink data needs the random access procedure, and is a newly-defined timer Tz under the condition of the random access procedure triggered by the event that the location of the UE needs the random access procedure. The timers Tx, Ty, and Tz are started when the UE initiates the random access procedure on the UL CC which selected firstly. The timers Tx, Ty, and Tz can also be the same timer. After the timers expire, the RRC connection re-establishment procedure is triggered.

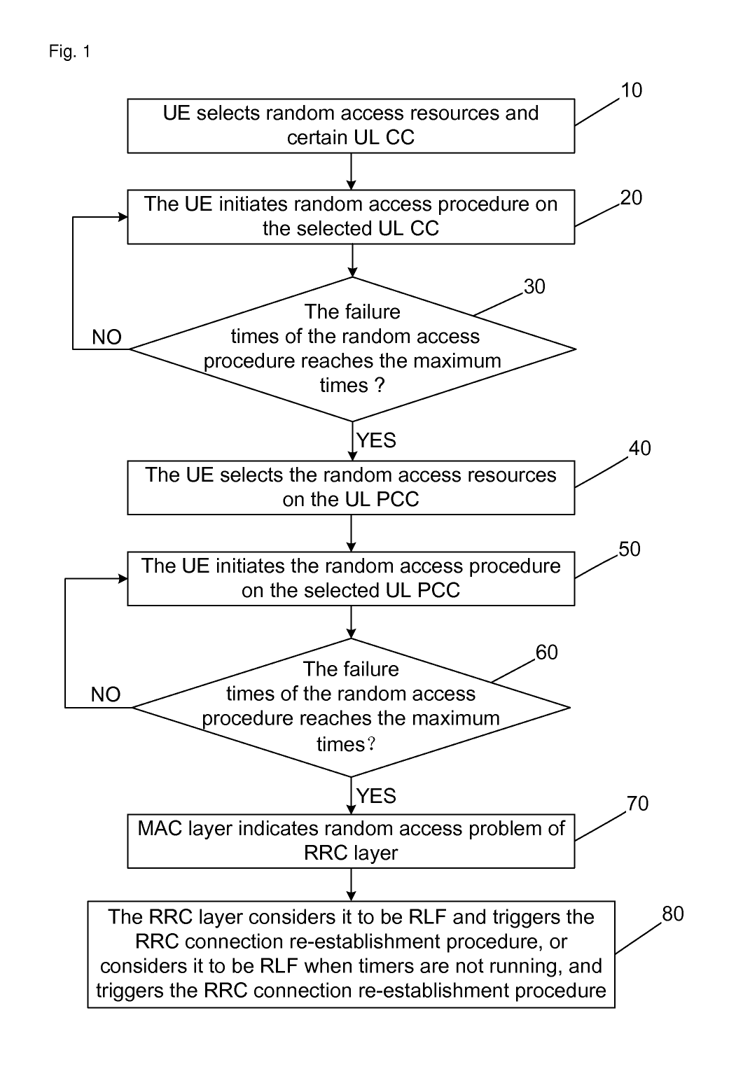

FIG. 1 is a flowchart of a method for triggering RRC connection re-establishment in the first embodiment of the disclosure, as shown in FIG. 1, the method for triggering RRC connection re-establishment in the embodiment includes following steps:

Step 10: The UE selects random access resources and certain UL CC; and the selection way is as what mentioned above.

Specifically, the principle for selecting the UL CC is:

the UE selects a UL CC to execute the random access procedure based on at least one of the following conditions:

based on the path loss of the DL CC associated with the UL CC (for example, selecting the UL CC whose associated DL CC has the minimum path loss), based on the path loss of the UL CC (for example, selecting the UL CC having the minimum path loss), based on the path loss of the DL CC which is associated with the UL CC and has the same frequency band with that of the UL CC (for example, selecting the UL CC whose associated DL CC has the same frequency band with that of the UL CC and has the minimum path loss), based on the Power Headroom Report (PHR) of the UE on the UL CC (for example, selecting the UL CC having the maximum PHR), based on the time-frequency domain configuration of random access resources (for example selecting the UL CC which is nearest to the random access channel), random selection and the like.

Step 20: The UE initiates the random access procedure on the selected UL CC.

Step 30: Whether the failure times of the random access procedure reaches the maximum times is judged, if not, Step 20 is executed, otherwise, Step 40 is executed.

Step 40: The UE selects the random access resources (i.e., RACH) on the UL PCC.

Step 50: The UE initiates the random access procedure on the selected UL PCC.

Step 60: Whether the failure times of the random access procedure reaches the maximum times is judged, if not, Step 50 is executed, otherwise, Step 70 is executed.

Step 70: The MAC layer indicates the random access problem of the RRC layer.

Step 80: The RRC layer considers it to be RLF and triggers the RRC connection re-establishment procedure. Or, the RRC layer further determines whether it is RLF according to the running conditions of the related timers mentioned above in the embodiment and triggers the RRC connection re-establishment procedure.

### Second Embodiment

In the embodiment, the RRC connection re-establishment procedure is triggered according to the failed random access procedure initiated on all the UL CCs, which is described below in detail.

The UE selects to initiate the random access procedure on certain UL CC, if the failure times of the random access procedure initiated on the UL CC reaches the maximum times preambleTransMax, then the random access procedure on another UL CC is selected to be initiated, and deducing the rest; if the failure times of the random access procedure initiated by the UE on each configured UL CC reaches the maximum times preambleTransMax, the MAC layer indicates the random access problem of the upper protocol layer, such as the RRC layer.

The UL CC configured by the UE refers to all the UL CCs that provided with random access resources for the UE or the subset of all the UL CCs or UL CCs preset with corresponding number; and the subset or number of the UL CCs is pre-configured to the UE. The subset contains UL PCCs and UL SCCs or only contains UL SCCS. The UL CCs preset with corresponding number contain UL PCCs and UL SCCs or only contain UL SCCs.

The RRC layer receives the indication from the MAC layer, considers it to be RLF and triggers the RRC connection re-establishment procedure.

In the embodiment, while initiating the random access procedure on each configured UL CC, the UE cannot repeatedly select the UL CCs on which the failure times of the random access procedure has reached the maximum times preambleTransMax; or, cannot repeatedly select the UL CCs on which the failure times of the random access procedure has reached the maximum times within a preset time range. Specifically, the UE records the selected times of each UL CC by a counter; each UL CC is provided with a corresponding counter whose initial value is 0; when the failure times of the random access procedure initiated by the UE on certain UL CC reaches the maximum times preambleTransMax, the value of the corresponding counter adds 1; when the value of the corresponding counter is 1, the corresponding UL CC cannot be selected for the initiation of the random access procedure. The counter is re-initialized after the triggering of the RRC connection re-establishment.

Or, the RRC layer receives the random access problem indicated by the MAC layer, considers it to be RLF when timers are not running and triggers the RRC connection re-establishment procedure. The timer is T301 and T311 under the condition of the random access procedure triggered by RRC connection re-establishment event, and is T304 under the condition of the random access procedure triggered by handover event; the defining, starting and stopping of the timers T301, T311 and T304 are completely the same as that in the related art and are stipulated in the related protocols, thereby needing no further description.

Or, the timer is a newly-defined timer Tx under the condition of the random access procedure triggered by the event that the arrival of downlink data needs the random access procedure, and is a newly-defined timer Ty under the condition of the random access procedure triggered by the event that the arrival of uplink data needs the random access procedure, and is a newly-defined timer Tz under the condition of the random access procedure triggered by the event that the location of the UE needs the random access procedure. The timers Tx, Ty, and Tz are started when the UE initiates the random access procedure on the UL CC which selected firstly. The timers Tx, Ty, and Tz can also be the same timer. After the timers expire, the RRC connection re-establishment procedure is triggered.

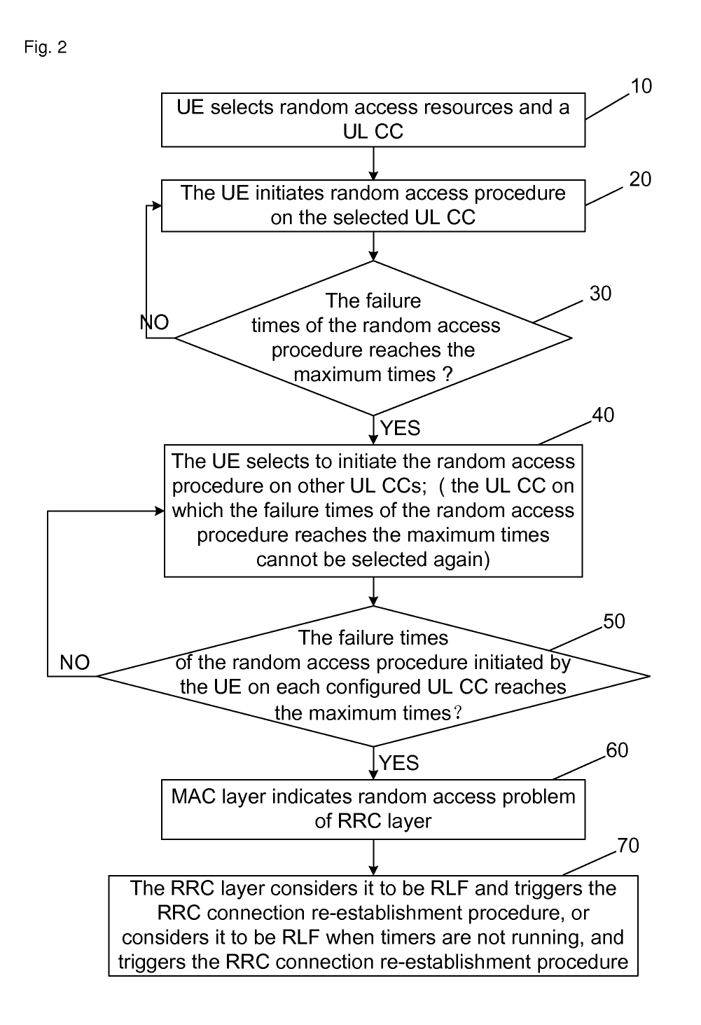

FIG. 2 is a flowchart of a method for triggering RRC connection re-establishment in the second embodiment of the disclosure, as shown in FIG. 2, the method for triggering RRC connection re-establishment in the embodiment includes following steps:

Step 10: The UE selects random access resources and certain UL CC.

Step 20: The UE initiates the random access procedure on the selected UL CC.

Step 30: Whether the failure times of the random access procedure reaches the maximum times is judged, if not, Step 20 is executed, otherwise, Step 40 is executed.

Step 40: The UE selects to initiate the random access procedure on other UL CCs; (the UL CC on which the failure times of the random access procedure reaches the maximum times cannot be selected again).

Step 50: Whether the failure times of the random access procedure reaches the maximum times is judged, if not, Step 40 is executed, otherwise, Step 60 is executed.

Step 60: The MAC layer indicates the random access problem of the RRC layer.

Step 70: The RRC layer considers it to be RLF and triggers the RRC connection re-establishment procedure. Or, the RRC layer further determines whether it is RLF according to the running conditions of the related timers as mentioned above in the embodiment, and triggers the RRC connection re-establishment procedure.

### Third Embodiment

When the failure times of the random access procedure initiated by the UE on specific UL CCs reaches the maximum times preambleTransMax, the MAC layer indicates the random access problem of the upper protocol layer, such as the RRC layer; the specific UL CCs can be UL PCCs or UL CCs meeting preset condition; and the UE prefers to select to initiate the random access procedure on the specific UL CCs.

The specific UL CCs are the ones with the best radio channel condition, or the ones whose associated DL CCs have the minimum path loss, or

the ones whose associated DL CCs have the same frequency band with that of the UL CCs and the minimum path loss, or

the ones having the minimum path loss, or

the ones having the maximum PHR, or,

the ones nearest to the RACH resources in time domain.

the RRC layer receives the indication from the MAC layer, considers it to be RLF and triggers the RRC connection re-establishment procedure.

Or, under two conditions above, the RRC layer receives the random access problem indicated by the MAC layer, considers it to be RLF when timers are not running and triggers the RRC connection re-establishment procedure. The timer is T301 and T311 under the condition of the random access procedure triggered by RRC connection re-establishment event, and is T304 under the condition of the random access procedure triggered by handover event; the defining, starting and stopping of the timers T301, T311 and T304 are completely the same as that in the related art and are stipulated in the related protocols, thereby needing no further description.

Or, the timer is a newly-defined timer Tx under the condition of the random access procedure triggered by the event that the arrival of downlink data needs the random access procedure, and is a newly-defined timer Ty under the condition of the random access procedure triggered by the event that the arrival of uplink data needs the random access procedure, and is a newly-defined timer Tz under the condition of the random access procedure triggered by the event that the location of the UE needs the random access procedure. The timers Tx, Ty, and Tz are started when the UE initiates the random access procedure on the UL CC which selected firstly. The timers Tx, Ty, and Tz can also be the same timer. After the timers expire, the RRC connection re-establishment procedure is triggered.

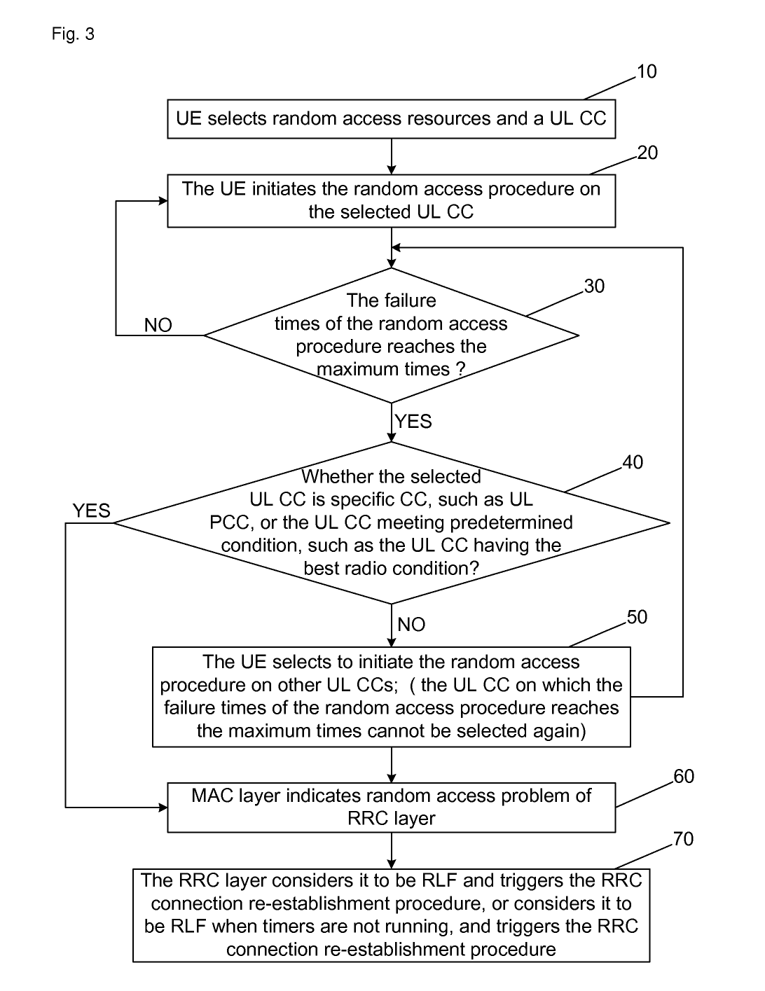

FIG. 3 is a flowchart of a method for triggering RRC connection re-establishment in the third embodiment of the disclosure, as shown in FIG. 3, the method for triggering RRC connection re-establishment in the embodiment includes following steps:

Step 10: The UE selects random access resources and a UL CC.

Step 20: The UE initiates the random access procedure on the selected UL CC.

Step 30: Whether the failure times of the random access procedure reaches the maximum times is judged, if not, Step 20 is executed, otherwise, Step 40 is executed.

Step 40: Whether the selected UL CC is a specific UL CC is judged, if not, Step 50 is executed, otherwise, Step 60 is executed.

Step 50: The UE selects to initiate the random access procedure on other UL CCs; (the UL CC on which the failure times of the random access procedure reaches the maximum times cannot be selected again), turning to Step 30.

Step 60: The MAC layer indicates the random access problem of the RRC layer.

Step 70: The RRC layer considers it to be RLF and triggers the RRC connection re-establishment procedure. Or, the RRC layer considers it to be RLF when the timers are not running and triggers the RRC connection re-establishment procedure.

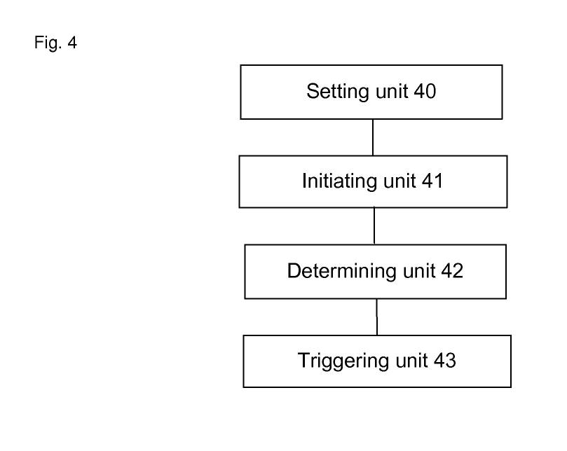

FIG. 4 is a diagram showing the composition structure of a device for triggering RRC connection re-establishment, as shown in FIG. 4, the device for triggering RRC connection re-establishment includes a setting unit 40, an initiating unit 41, a determining unit 42 and a triggering unit 43, wherein

the setting unit 40 is configured to set a random access policy for a UE;

the initiating unit 41 is configured to initiate random access procedure according to the set random access policy;

the determining unit 42 is configured to determine whether the random access procedure initiated by the initiating unit 41 is successful, and triggering the triggering unit if the random access procedure is failed; and

the triggering unit 43 is configured to triggering RRC connection re-establishment procedure.

The random access policy is: the UE initiates random access on the set UL CCs.

Preferably, the set UL CCs include a UL PCC and at least one UL SCC; and

the determining unit 42 further determines: initiating the random access procedure on the UL PCC when the initiating unit 41 firstly initiates the random access procedure on the UL SCCs and the random access procedure initiated on at least one of the UL SCCs is failed, and determining the random access procedure initiated on the set UL CC is failed when the random access procedure initiated on the UL PCC is failed.

Preferably, the set UL CCs are UL PCCs; and

the determining unit 42 further determines: the random access procedure initiated on the set UL CCs is failed when the initiating unit 41 firstly initiates the random access procedure on the UL PCCs and the random access procedure initiated on the UL PCCs is failed.

The set UL CCs are specific UL CCs; and

the determining unit 42 further determines: the random access procedure initiated on the set UL CCs is failed when the random access procedure initiated by the initiating unit 41 on the specific UL CCs is failed.

The specific UL CCs are the ones with the best radio channel condition; or

the ones whose associated DL CCs have the minimum path loss, or

the ones whose associated DL CCs have the same frequency band with that of the UL CCs and the minimum path loss, or

the ones having the minimum path loss, or

the ones having the maximum PHR, or,

the ones nearest to the RACH resources in time domain.

Or, the random access policy is: a maximum number of UL CCs for the initiation of random access attempt are set for the UE; and

the determining unit 42 further determines: the initiated random access procedure is failed when the initiating unit 41 initiates the random access procedure on the selected UL CCs and the random access procedure is failed while the amount of the selected UL CCs reaches set maximum amount.

Or, the random access policy is: the set of UL CCs for the initiation of random access is set for the UE; and

the determining unit 42 further determines: the initiated random access procedure is failed when the random access procedure initiated by the initiating unit 41 on all the UL CCs in the set of UL CCs is failed.

Those skilled in the art should understand that the device for triggering RRC connection re-establishment in FIG. 4 is designed for implementing the above-mentioned method for triggering RRC connection re-establishment; and the implementing function of each processing unit in FIG. 4 can be understood with reference to the related description of the method. The function of each processing unit of the system in FIG. 4 can be realized by program running on a processor and can also be realized by a specific logic circuit.

What described above are only preferred embodiments of the disclosure, and the scope of protection of the disclosure is not limited herein.

1. A method for triggering Radio Resource Control (RRC) connection re-establishment, comprising setting a random access policy for a user, and further comprising:
triggering RRC connection re-establishment procedure when the random access procedure initiated by the User Equipment (UE) according to the set random access policy is failed.

2. The method according to claim 1, wherein the random access policy is:
initiating random access on set Uplink Component Carriers (UL CCs) by the UE.

3. The method according to claim 2, wherein the set UL CCs comprise a Uplink Primary Component Carrier (UL PCC) and at least one Uplink Secondary Component Carrier (UL SCC); and
the failed random access procedure initiated by the UE according to the set random access policy is:
initiating the random access procedure on the UL PCC when the UE firstly initiates the random access procedure on the UL SCCs and the random access procedure initiated on at least one of the UL SCCs is failed, and determining the random access procedure initiated on the set UL CC is failed when the random access procedure initiated on the UL PCC is failed.

4. The method according to claim 2, wherein the set UL CCs are UL PCCs; and
the failed random access procedure initiated by the UE according to the set random access policy is:
determining that the random access procedure initiated on the set UL CCs is failed when the UE firstly initiates the random access procedure on the UL PCCs and the random access procedure initiated on the UL PCCs is failed.

5. The method according to claim 2, wherein the set UL CCs are specific UL CCs; and
the failed random access procedure initiated by the UE according to the set random access policy is:
determining that the random access procedure initiated on the set UL CCs is failed when the random access procedure initiated on the specific UL CCs is failed.

6. The method according to claim 5, wherein the specific UL CCs are the ones with the best radio channel condition, or
the ones whose associated Downlink Component Carriers (DL CCs) have the minimum path loss, or
the ones whose associated DL CCs have the same frequency band with that of the UL CCs and the minimum path loss, or
the ones having the minimum path loss, or
the ones having the maximum Power Headroom Report (PHR), or,
the ones nearest to Random Access Channel (RACH) resources in time domain.

7. The method according to claim 1, wherein the random access policy is:
a maximum number of UL CCs for the initiation of random access attempt are set for the UE; and
the failed random access procedure initiated by the UE according to the set random access policy is:
determining that the initiated random access procedure is failed when the UE initiates the random access procedure on the selected UL CCs and the random access procedure is failed while the amount of the selected UL CCs reaches set maximum amount.

8. The method according to claim 7, wherein the selected UL CCs comprise UL PCCs and UL SCCs; or, only comprise UL SCCs.

9. The method according to claim 1, wherein the random access policy is:
the set of UL CCs for the initiation of random access is set for the UE; and
the failed random access procedure initiated by the UE according to the set random access policy is:
determining that the initiated random access procedure is failed when the random access procedure initiated by the UE on all the UL CCs in the set of UL CCs is failed.

10. The method according to claim 3, further comprising:
determining that the random access procedure initiated on the UL CCs is failed when the failure times of the random access procedure initiated on each UL CC reaches set maximum times; and the failure times of the random access procedure initiated on the UL CCs does not exceed the set maximum times.

11. The method according to claim 10, wherein the triggering of the RRC connection re-establishment procedure specifically is:
Indicating, by an Medium Access Control (MAC) layer, random access problem of an upper protocol layer, such as an RRC layer, after the UE determines that the random access procedure initiated according to the set random access policy is failed, receiving, by the upper protocol layer RRC layer, the indication of the MAC layer and considering it to be RLF, then triggering the RRC connection re-establishment procedure.

12. The method according to claim 11, wherein before the triggering of the RRC connection re-establishment procedure, the method further comprises:
determining whether corresponding timers are running and triggering the RRC connection re-establishment procedure when the timers are not running.

13. The method according to claim 12, wherein the corresponding timers comprise T301, T311, and T304; and
determining whether corresponding timers are running is: determining whether T301 and/or T311 is running under the condition of the random access procedure triggered by RRC connection re-establishment event; and determining whether T304 is running under the condition of the random access procedure triggered by handover event.

14. The method according to claim 11, further comprising: setting timer Tx under the condition of the random access procedure triggered by the event that the arrival of downlink data needs the random access procedure, timer Ty under the condition of the random access procedure triggered by the event that the arrival of uplink data needs the random access procedure, and timer Tz under the condition of the random access procedure triggered by the event that the location of the UE needs the random access procedure, wherein the timers Tx, Ty and Tz are started when the UE initiates the random access procedure on the UL CC which selected firstly;
before the triggering of the RRC connection re-establishment procedure, the method further comprises: determining whether the corresponding timers expire; and
triggering the RRC connection re-establishment procedure if the corresponding timers expire, wherein the corresponding timers are at least one of the Tx, Ty and Tz.

15. A device for triggering Radio Resource Control (RRC) connection re-establishment, comprises a setting unit, an initiating unit, a determining unit and a triggering unit, wherein
the setting unit is configured to set a random access policy for a User Equipment (UE);
the initiating unit is configured to initiate random access procedure according to the set random access policy;
the determining unit is configured to determine whether the random access procedure initiated by the initiating unit is successful, and trigger the triggering unit if the random access procedure is failed; and
the triggering unit is configured to trigger RRC connection re-establishment procedure.

16. The device according to claim 15, wherein the random access policy is: the UE initiates random access on set Uplink Component Carriers (UL CCs).

17. The device according to claim 16, wherein the set UL CCs comprise a Uplink Primary Component Carrier (UL PCC) and at least one Uplink Secondary Component Carrier (UL SCC); and
the determining unit is further configured to determine: initiating the random access procedure on the UL PCC when the initiating unit firstly initiates the random access procedure on the UL SCCs and the random access procedure initiated on at least one of the UL SCCs is failed, and determining the random access procedure initiated on the set UL CC is failed when the random access procedure initiated on the UL PCC is failed.

18. The device according to claim 16, wherein the set UL CCs are UL PCCs; and
the determining unit is further configured to determine: the random access procedure initiated on the set UL CCs is failed when the initiating unit firstly initiates the random access procedure on the UL PCCs and the random access procedure initiated on the UL PCCs is failed.

19. The device according to claim 16, wherein the set UL CCs are specific UL CCs; and
the determining unit is further configured to determine: the random access procedure initiated on the set UL CCs is failed when the random access procedure initiated by the initiating unit on the specific UL CCs is failed.

20. The device according to claim 19, wherein the specific UL CCs are the ones with the best radio channel condition, or
the ones whose associated Downlink Component Carriers (DL CCs) have the minimum path loss, or
the ones whose associated DL CCs have the same frequency band with that of the UL CCs and the minimum path loss, or
the ones having the minimum path loss, or
the ones having the maximum Power Headroom Report (PHR), or,
the ones nearest to the Random Access Channel (RACH) resources in time domain.

21. The device according to claim 15, wherein the random access policy is: a maximum number of UL CCs for the initiation of the random access attempt are set for the UE; and
the determining unit is further configured to determine that the initiated random access procedure is failed when the initiating unit initiates the random access procedure on the selected UL CCs and the random access procedure is failed while the amount of the selected UL CCs reaches set maximum amount.

22. The device according to claim 15, wherein the random access policy is: the set of UL CCs for the initiation of random access is set for the UE; and
the determining unit is further configured to determine that the initiated random access procedure is failed when the random access procedure initiated by the initiating unit on all the UL CCs in the set of the UL CCs is failed.

23. The method according to claim 4, further comprising:
determining that the random access procedure initiated on the UL CCs is failed when the failure times of the random access procedure initiated on each UL CC reaches set maximum times; and the failure times of the random access procedure initiated on the UL CCs does not exceed the set maximum times.

24. The method according to claim 5, further comprising:
determining that the random access procedure initiated on the UL CCs is failed when the failure times of the random access procedure initiated on each UL CC reaches set maximum times; and the failure times of the random access procedure initiated on the UL CCs does not exceed the set maximum times.

25. The method according to claim 6, further comprising:
determining that the random access procedure initiated on the UL CCs is failed when the failure times of the random access procedure initiated on each UL CC reaches set maximum times; and the failure times of the random access procedure initiated on the UL CCs does not exceed the set maximum times.

26. The method according to claim 7, further comprising:
determining that the random access procedure initiated on the UL CCs is failed when the failure times of the random access procedure initiated on each UL CC reaches set maximum times; and the failure times of the random access procedure initiated on the UL CCs does not exceed the set maximum times.

27. The method according to claim 8, further comprising:
determining that the random access procedure initiated on the UL CCs is failed when the failure times of the random access procedure initiated on each UL CC reaches set maximum times; and the failure times of the random access procedure initiated on the UL CCs does not exceed the set maximum times.

28. The method according to claim 9, further comprising:
determining that the random access procedure initiated on the UL CCs is failed when the failure times of the random access procedure initiated on each UL CC reaches set maximum times; and the failure times of the random access procedure initiated on the UL CCs does not exceed the set maximum times.

29. The method according to claim 23, wherein the triggering of the RRC connection re-establishment procedure specifically is:
Indicating, by an Medium Access Control (MAC) layer, random access problem of an upper protocol layer, such as an RRC layer, after the UE determines that the random access procedure initiated according to the set random access policy is failed, receiving, by the upper protocol layer RRC layer, the indication of the MAC layer and considering it to be RLF, then triggering the RRC connection re-establishment procedure.

30. The method according to claim 24, wherein the triggering of the RRC connection re-establishment procedure specifically is:
Indicating, by an Medium Access Control (MAC) layer, random access problem of an upper protocol layer, such as an RRC layer, after the UE determines that the random access procedure initiated according to the set random access policy is failed, receiving, by the upper protocol layer RRC layer, the indication of the MAC layer and considering it to be RLF, then triggering the RRC connection re-establishment procedure.

31. The method according to claim 25, wherein the triggering of the RRC connection re-establishment procedure specifically is:
Indicating, by an Medium Access Control (MAC) layer, random access problem of an upper protocol layer, such as an RRC layer, after the UE determines that the random access procedure initiated according to the set random access policy is failed, receiving, by the upper protocol layer RRC layer, the indication of the MAC layer and considering it to be RLF, then triggering the RRC connection re-establishment procedure.

32. The method according to claim 26, wherein the triggering of the RRC connection re-establishment procedure specifically is:
Indicating, by an Medium Access Control (MAC) layer, random access problem of an upper protocol layer, such as an RRC layer, after the UE determines that the random access procedure initiated according to the set random access policy is failed, receiving, by the upper protocol layer RRC layer, the indication of the MAC layer and considering it to be RLF, then triggering the RRC connection re-establishment procedure.

33. The method according to claim 27, wherein the triggering of the RRC connection re-establishment procedure specifically is:
Indicating, by an Medium Access Control (MAC) layer, random access problem of an upper protocol layer, such as an RRC layer, after the UE determines that the random access procedure initiated according to the set random access policy is failed, receiving, by the upper protocol layer RRC layer, the indication of the MAC layer and considering it to be RLF, then triggering the RRC connection re-establishment procedure.

34. The method according to claim 28, wherein the triggering of the RRC connection re-establishment procedure specifically is:
Indicating, by an Medium Access Control (MAC) layer, random access problem of an upper protocol layer, such as an RRC layer, after the UE determines that the random access procedure initiated according to the set random access policy is failed, receiving, by the upper protocol layer RRC layer, the indication of the MAC layer and considering it to be RLF, then triggering the RRC connection re-establishment procedure.

35. The method according to claim 29, wherein before the triggering of the RRC connection re-establishment procedure, the method further comprises:
determining whether corresponding timers are running and triggering the RRC connection re-establishment procedure when the timers are not running.

36. The method according to claim 30, wherein before the triggering of the RRC connection re-establishment procedure, the method further comprises:
determining whether corresponding timers are running and triggering the RRC connection re-establishment procedure when the timers are not running.

37. The method according to claim 31, wherein before the triggering of the RRC connection re-establishment procedure, the method further comprises:
determining whether corresponding timers are running and triggering the RRC connection re-establishment procedure when the timers are not running.

38. The method according to claim 32, wherein before the triggering of the RRC connection re-establishment procedure, the method further comprises:
determining whether corresponding timers are running and triggering the RRC connection re-establishment procedure when the timers are not running.

39. The method according to claim 33, wherein before the triggering of the RRC connection re-establishment procedure, the method further comprises:
determining whether corresponding timers are running and triggering the RRC connection re-establishment procedure when the timers are not running.

40. The method according to claim 34, wherein before the triggering of the RRC connection re-establishment procedure, the method further comprises:
determining whether corresponding timers are running and triggering the RRC connection re-establishment procedure when the timers are not running.

41. The method according to claim 35, wherein the corresponding timers comprise T301, T311, and T304; and
determining whether corresponding timers are running is: determining whether T301 and/or T311 is running under the condition of the random access procedure triggered by RRC connection re-establishment event; and determining whether T304 is running under the condition of the random access procedure triggered by handover event.

42. The method according to claim 36, wherein the corresponding timers comprise T301, T311, and T304; and
determining whether corresponding timers are running is: determining whether T301 and/or T311 is running under the condition of the random access procedure triggered by RRC connection re-establishment event; and determining whether T304 is running under the condition of the random access procedure triggered by handover event.

43. The method according to claim 37, wherein the corresponding timers comprise T301, T311, and T304; and
determining whether corresponding timers are running is: determining whether T301 and/or T311 is running under the condition of the random access procedure triggered by RRC connection re-establishment event; and determining whether T304 is running under the condition of the random access procedure triggered by handover event.

44. The method according to claim 38, wherein the corresponding timers comprise T301, T311, and T304; and
determining whether corresponding timers are running is: determining whether T301 and/or T311 is running under the condition of the random access procedure triggered by RRC connection re-establishment event; and determining whether T304 is running under the condition of the random access procedure triggered by handover event.

45. The method according to claim 39, wherein the corresponding timers comprise T301, T311, and T304; and
determining whether corresponding timers are running is: determining whether T301 and/or T311 is running under the condition of the random access procedure triggered by RRC connection re-establishment event; and determining whether T304 is running under the condition of the random access procedure triggered by handover event.

46. The method according to claim 40, wherein the corresponding timers comprise T301, T311, and T304; and
determining whether corresponding timers are running is: determining whether T301 and/or T311 is running under the condition of the random access procedure triggered by RRC connection re-establishment event; and determining whether T304 is running under the condition of the random access procedure triggered by handover event.

47. The method according to claim 29, further comprising: setting timer Tx under the condition of the random access procedure triggered by the event that the arrival of downlink data needs the random access procedure, timer Ty under the condition of the random access procedure triggered by the event that the arrival of uplink data needs the random access procedure, and timer Tz under the condition of the random access procedure triggered by the event that the location of the UE needs the random access procedure, wherein the timers Tx, Ty and Tz are started when the UE initiates the random access procedure on the UL CC which selected firstly;
before the triggering of the RRC connection re-establishment procedure, the method further comprises: determining whether the corresponding timers expire; and
triggering the RRC connection re-establishment procedure if the corresponding timers expire, wherein the corresponding timers are at least one of the Tx, Ty and Tz.

48. The method according to claim 30, further comprising: setting timer Tx under the condition of the random access procedure triggered by the event that the arrival of downlink data needs the random access procedure, timer Ty under the condition of the random access procedure triggered by the event that the arrival of uplink data needs the random access procedure, and timer Tz under the condition of the random access procedure triggered by the event that the location of the UE needs the random access procedure, wherein the timers Tx, Ty and Tz are started when the UE initiates the random access procedure on the UL CC which selected firstly;
before the triggering of the RRC connection re-establishment procedure, the method further comprises: determining whether the corresponding timers expire; and
triggering the RRC connection re-establishment procedure if the corresponding timers expire, wherein the corresponding timers are at least one of the Tx, Ty and Tz.

49. The method according to claim 31, further comprising: setting timer Tx under the condition of the random access procedure triggered by the event that the arrival of downlink data needs the random access procedure, timer Ty under the condition of the random access procedure triggered by the event that the arrival of uplink data needs the random access procedure, and timer Tz under the condition of the random access procedure triggered by the event that the location of the UE needs the random access procedure, wherein the timers Tx, Ty and Tz are started when the UE initiates the random access procedure on the UL CC which selected firstly;
before the triggering of the RRC connection re-establishment procedure, the method further comprises: determining whether the corresponding timers expire; and
triggering the RRC connection re-establishment procedure if the corresponding timers expire, wherein the corresponding timers are at least one of the Tx, Ty and Tz.

50. The method according to claim 32, further comprising: setting timer Tx under the condition of the random access procedure triggered by the event that the arrival of downlink data needs the random access procedure, timer Ty under the condition of the random access procedure triggered by the event that the arrival of uplink data needs the random access procedure, and timer Tz under the condition of the random access procedure triggered by the event that the location of the UE needs the random access procedure, wherein the timers Tx, Ty and Tz are started when the UE initiates the random access procedure on the UL CC which selected firstly;
before the triggering of the RRC connection re-establishment procedure, the method further comprises: determining whether the corresponding timers expire; and
triggering the RRC connection re-establishment procedure if the corresponding timers expire, wherein the corresponding timers are at least one of the Tx, Ty and Tz.

51. The method according to claim 33, further comprising: setting timer Tx under the condition of the random access procedure triggered by the event that the arrival of downlink data needs the random access procedure, timer Ty under the condition of the random access procedure triggered by the event that the arrival of uplink data needs the random access procedure, and timer Tz under the condition of the random access procedure triggered by the event that the location of the UE needs the random access procedure, wherein the timers Tx, Ty and Tz are started when the UE initiates the random access procedure on the UL CC which selected firstly;
before the triggering of the RRC connection re-establishment procedure, the method further comprises: determining whether the corresponding timers expire; and
triggering the RRC connection re-establishment procedure if the corresponding timers expire, wherein the corresponding timers are at least one of the Tx, Ty and Tz.

52. The method according to claim 34, further comprising: setting timer Tx under the condition of the random access procedure triggered by the event that the arrival of downlink data needs the random access procedure, timer Ty under the condition of the random access procedure triggered by the event that the arrival of uplink data needs the random access procedure, and timer Tz under the condition of the random access procedure triggered by the event that the location of the UE needs the random access procedure, wherein the timers Tx, Ty and Tz are started when the UE initiates the random access procedure on the UL CC which selected firstly;
before the triggering of the RRC connection re-establishment procedure, the method further comprises: determining whether the corresponding timers expire; and
triggering the RRC connection re-establishment procedure if the corresponding timers expire, wherein the corresponding timers are at least one of the Tx, Ty and Tz.
